(19) United States
(12) Patent Application Publication
(10) Pub. No.: US 2019/0210580 A1
(43) Pub. Date: Jul. 11, 2019

(54) PNEUMATIC SYSTEM FOR MOTOR VEHICLES

(71) Applicant: Adolf KOCHSIEK, Leopoldshöhe (DE)

(72) Inventor: Adolf KOCHSIEK, Leopoldshöhe (DE)

(21) Appl. No.: 16/310,552

(22) PCT Filed: Jun. 23, 2017
(86) PCT No.: PCT/EP2017/065546

§ 371 Date: Dec. 17, 2018

(30) Foreign Application Priority Data
Jun. 23, 2016 (EP) 16175894.1

(51) Int. Cl. B60T 13/36; F15B 1/26; F15B 7/06; B60T 13/26; B60T 17/06; B60T 13/68; B60T 17/02; B60T 17/04

(52) U.S. Cl. CPC B60T 13/36; F15B 1/265; F15B 7/06; B60T 17/04; B60T 17/06; B60T 13/683; B60T 17/02; B60T 13/268

(57) ABSTRACT

In order to provide a pneumatic system for motor vehicles, which system is lightweight and environmentally friendly and furthermore flexible with respect to further developments and adaptations to modern vehicle systems, the invention proposes a pneumatic system for motor vehicles, comprising at least one compressed air reservoir, a compressor, a valve unit that can be controlled by a control unit and a pipe system, in order to supply compressed air that has been generated by means of the compressor and stored in the compressed air reservoir to an operable actuator.

### CROSS-REFERENCE TO RELATED APPLICATIONS

This application is a National Stage of International Application No. PCT/EP2017/065546 filed on Jun. 23, 2017. This application claims the priority to European Patent Application No. 16175894.1, filed on Jun. 23, 2016. The entire disclosures of the above applications are incorporated herein by reference.

### FIELD

The present invention relates to a pneumatic system for motor vehicles.

### BACKGROUND

This section provides background information related to the present disclosure which is not necessarily prior art.

There are only a few pneumatic applications in the field of motor vehicles. It is known to pneumatically design shock absorbers or other chassis damping systems. Furthermore, force generating systems, for example brake systems, are conceived hydraulically, others are designed purely electrically, such as for example window regulators, light adjustment systems, power steerings and the like.

The hitherto used systems represent an already mature technology and can be modified only slightly. In particular, it is difficult to adapt them to new vehicle developments. Newly developed vehicle types, such as for example hybrid vehicles or electric vehicles, are constructed under economic aspects. Herein, a primary task is in particular the weight reduction. In the known systems it is however hardly possible anymore to further reduce the weight. Furthermore, the systems especially consume electric energy, in the case of brake systems they consume mechanic energy which is converted into a hydraulic pressure by means of a hydraulic pump. For this purpose an additional liquid is required such that these systems are expensive. Corresponding power boosters and the like have to be included. Especially in the case of electric vehicles the additional weight of the battery has to be compensated.

### SUMMARY

This section provides a general summary of the disclosure, and is not a comprehensive disclosure of its full scope or all of its features.

Based upon the above described state of the art it is the object of the invention to provide a pneumatic system for motor vehicles which is lightweight and environmentally friendly and furthermore flexible with respect to further developments and adaptations to modern vehicle systems.

For the technical solution of this problem, a pneumatic system comprising the features of claim 1 is proposed. Other advantages and features will become apparent from the subclaims.

According to the invention, the pneumatic system for motor vehicles comprises, apart from a compressed air reservoir, also a compressor which fills the compressed air reservoir during the operation of the motor vehicle. Corresponding pipe systems and controllable valve units allow supplying compressed air to corresponding actuators. In this way, the different systems in a motor vehicle can be operated pneumatically.

Usually, the pneumatic modules are lighter than a plurality of electric or even hydraulic systems. The use of substances that are harmful to the environment is avoided and energy is usually saved.

Thanks to the fact that the compressed air will be economically produced during the operation of the vehicle, no further energy costs are incurred. Many functions in the motor vehicle are realised electrically. Many electric systems can be converted to pneumatic functioning, for example window regulators, seat adjustments, lumbar supports, seat firmness adjustments, windscreen wipers, locking systems, clutches, differentials and even gear actuations, headlight adjustment systems, cornering light, passenger compartment aeration, boot actuation etc.

Furthermore, also functional systems can be adapted to a functioning with compressed air, in particular brake systems.

Advantageously, the system can be operated with pressures of less than 25 bar and is thus no source of risk.

As a special advantage it is proposed that a plurality of compressed air reservoirs is provided. This makes it possible to feed systems with compressed air in a redundant manner, in order to avoid and to bridge system failures. The compressed air reservoirs are advantageously located in the front area of the vehicle, such that they can offer an additional safety aspect during accidents. For this purpose, it is proposed as a special advantage to arrange the compressed air reservoirs in form of a beam beneath the windscreen. Herein, each compressed air reservoir can be beam-shaped and a plurality of such reservoirs can be arranged in parallel or a beam-shaped reservoir is formed by placing several reservoirs next to each other.

Furthermore, it is advantageously proposed that at least one actuating member for triggering by an operator is provided. This can be for example a pedal, a switch, a control element or the like.

For producing the pressure, examples are also known which are based upon the proposal to accommodate a wind generator for generating electric energy on a passenger car in an area that is surrounded by air flows.

A system is proposed in which a wind turbine, a compressor and a compressed air reservoir cooperate. The wind turbine is driven by the relative movement of the vehicle through the ambient air. The wind turbine drives a compressor which in turn fills the compressed air reservoir.

In the sense of the present invention a compressor is understood to be a kind of air compressor and thus the turbine can also comprise a simple compressor stage.

Advantageously, the wind turbine can be a radial impeller to which dynamic pressure is applied. The invention assumes that a dynamic pressure is generated anyway in moved vehicles. Thus, this dynamic pressure is a cost-efficient energy source.

Thanks to the invention, all the systems that have been designed as electric systems hitherto can be relieved. The most different systems can be designed pneumatically, i.e. spring systems, lifter systems and the like.

According to another proposal of the invention, the wind turbine can alternatively also be driven mechanically. In this way it is possible to charge the compressed air reservoir even in the stationary condition. For this purpose, for example an electric motor, a combustion engine or the like can be used.

According to another advantageous proposal of the invention, a multi-stage storage unit can be considered as compressed air reservoir. Thus, several compressed air reservoirs can be charged in parallel, in order to be available as redundant compressed air source. These compressed air reservoirs can be for example located in the front area of a passenger compartment and provide another safety buffer in this way.

Thanks to the invention, compressed air is available as an alternative energy source. This one can be reused for any purposes in case of need by discharging the compressed air reservoirs. Examples of application are the generation of electric energy as well as the replacement of hydraulic or electric systems by now pneumatic systems.

As another advantage it is proposed that the compressor comprises a piston with adjustable stroke. This technology enables to carry out a lifting movement even in case of minor movements of the wind turbine. In this way, compressed air is generated in all driving conditions, and this in a corresponding amount depending on the advance rate.

An exemplary application field of pneumatics in vehicles are brake systems.

Brake systems are widely known and used. In the field of passenger cars hydraulic brake systems have become widespread. Herein, a brake fluid is guided under pressure from a storage to the brake shoes and causes a movement of the brake shoes in the direction of a brake disc. These systems have numerous disadvantages. An essential disadvantage is the necessity to generate, store and use a separate medium, the brake fluid. This one has hygroscopic properties and has therefore to be replaced regularly. A storage, a brake master cylinder, pipes and valves represent heavy systems. As a whole, a hydraulic brake system is heavy.

In the field of trucks, pneumatic brake systems are known, but only a power-operated piston applies pressure on a loaded system. It is not really a pneumatic system as it cannot be compared to this one, but rather represents a pneumatic reinforcement.

Hydraulic brake systems essentially represent a mature technology. They can only be slightly modified and are in particular not very adaptable with respect to new vehicle developments. Newly developed vehicle types, such as for example hybrid vehicles or electric vehicles, require different braking periods and different braking torques. Electric motors are practically switched on and off, i.e. torques which act upon wheels are spontaneous and have to be correspondingly reactive. Furthermore, there is a principal need to reduce weight in vehicles, whenever this is possible, in order to optimize the consumption with respect to an adequate performance.

For a technical improvement, a brake system for vehicles is proposed which comprises a brake unit composed of a brake disk and a brake piston unit, wherein a compressed air reservoir which is filled with compressed air will be discharged by means of a control unit such that compressed air for being applied to the brake piston unit will be supplied according to the needs.

The needs-based supply depends on a signal generator which in conventional ways can be a pedal or also any kind of switch. The indication of the brake pressure requirement can be purely digital or electronic and no physical force has to be applied anymore. Like this, the system is in particular also suitable for handicapped people or completely alternative actuating operations.

The system according to the invention stands out for a special leakage tightness of the individual aggregates and a good controllability. Furthermore it is not easily prone to leakages and does in particular not cause damages to the environment in case of leakages.

The pneumatic system is cheaper and in particular better suitable for new electric drive systems.

Of course, the brake system according to the invention comprises a brake piston unit which is arranged in the area of for example a brake disk and on which compressed air can be applied via a valve that is triggered by a control unit while using corresponding pipes. The compressed air comes from one or several storages which are also connected to the corresponding valve or the control unit by means of pipes. An actuation unit can initiate a braking process directly via the valves or indirectly and also for example in a digital manner via the control unit. In a conventional way this can be a pedal or even a joystick-like brake control. Any kind of actuating unit is imaginable.

A great advantage of the system becomes apparent if smaller pressures of less than 25 bars are used. For pistons having correspondingly great surfaces, which pistons are manufactured in a non-round manner according to an advantageous proposal of the invention, and which pistons thus have for example an elliptic cross section, these pressures are sufficient. In case of correspondingly non-round contours, great piston surfaces can be used, in order to obtain in this way correspondingly good braking results.

Storages are provided in a multiple redundant way. At least one storage is provided as emergency storage according to the invention. According to another advantageous proposal, one emergency storage is provided for each wheel. Thus, an increased safety with respect to the usability of the system is obtained.

The safety is further increased thanks to the use of multiple circuit systems. According to an especially advantageous proposal of the invention, a four circuit system can be used. It is also imaginable to use this one in the function of a cross connection, in order to be able to couple the circuit of a wheel to a broken down circuit of another wheel.

The system according to the invention offers a high number of advantages. In case of a leakage, it doesn't cause damages to the environment. Furthermore, the system can always be refilled, since only compressed air has to be resupplied. It is possible to at least maintain a minimum of functionality. Brake liquid will be completely dispensed with, in particular also the frequent replacement thereof, which makes up a big amount in view of the high number of vehicles. Furthermore, it is possible to reduce a lot of weight, since brake boosters and similar additional aggregates can also be completely omitted. In case of using big brake pistons which can be manufactured by means of new technologies, such as non-round turning, it is possible to work with pressures that are low. Since air can principally be compressed, which is basically not the case for hydraulics, also this factor can be taken into account by the use of big pistons. The system according to the invention addresses the brake pistons always directly and not indirectly via any intermediate aggregates. The piston acts directly upon the brake shoe and thus constitutes a brake. Furthermore, in comparison to usual systems the pneumatic system is extremely fast.

The pneumatic system according to the invention enables to obtain considerable weight reductions in the vehicle construction. The use of environmentally harmful substances is avoided and energy is saved.

### DRAWINGS

The drawings described herein are for illustrative purposes only of selected embodiments and not all possible implementations, and are not intended to limit the scope of the present disclosure.

Other advantages and features of the invention will become apparent from the following description by means of the FIGURES. Herein:

FIG. 1 is a schematic representation of an exemplary embodiment of a brake system according to the invention.

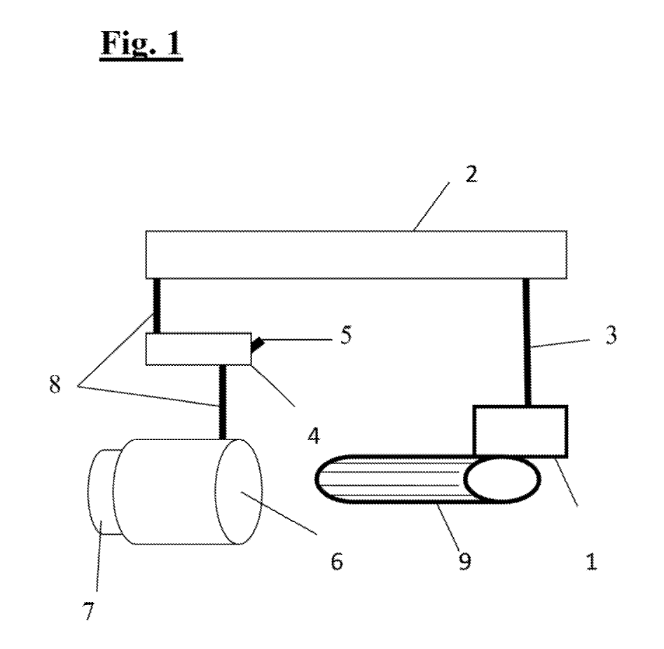

Corresponding reference numerals indicate corresponding parts throughout the drawing.

### DETAILED DESCRIPTION

Example embodiments will now be described more fully with reference to the accompanying drawing.

A compressor or a compressed air source 1 that fills a compressed air reservoir 2 is shown purely schematically. For this purpose, the compressed air source 1 is connected to the storage by means of corresponding pipes 3. A control unit 4, which can be operated in the shown exemplary embodiment by means of a directly connected actuating member 5, can supply compressed air from the storage 2 via the pipes 8 to a cylinder 6, in which a piston 7 is guided. Herein, the piston can be a brake piston which directly actuates a brake shoe. This one will then act upon a not shown brake disk of a vehicle.

A generator 9 is also shown in the shown exemplary embodiment, which generator is stylized as a radial impeller. The radial impeller can be for example arranged in the dynamic pressure area of a vehicle and operate the compressed air source 1 designed as a compressor.

The described exemplary embodiment only serves for explanation and is not limiting.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A pneumatic system for motor vehicles, comprising at least one compressed air reservoir, a compressor, a valve unit that can be controlled by a control unit and a pipe system, in order to supply compressed air that has been generated by means of the compressor and stored in the compressed air reservoir to an operable actuator.

2. The pneumatic system according to claim 1, wherein the at least one compressed air reservoir comprises several compressed air reservoirs.

3. The pneumatic system according to claim 1, wherein the at least one compressed air reservoir is arranged in the front area of the vehicle.

4. The pneumatic system according to claim 3, wherein the at least one compressed air reservoir is beam-shaped and arranged beneath the windscreen of a vehicle.

5. The pneumatic system according to claim 1, wherein the at least one compressed air reservoir comprises an actuating member for triggering by an operator.

6. The pneumatic system according to claim 1, wherein the at least one compressed air reservoir functions at a pressure of less than 25 bar.

7. The pneumatic system according to claim 1, wherein the at least one air reservoir comprises a wind turbine.

8. The pneumatic system according to claim 7, wherein the wind turbine will be driven by the airstream of the vehicle.

9. The pneumatic system according to claim 7 wherein the wind turbine is arranged in the area of dynamic pressure of the vehicle.

10. The pneumatic system according to claim 1, wherein the compressor comprises a piston with adjustable stroke.

11. The pneumatic system according to claim 1, wherein the at least one compressed air reservoir is integrated into the bodywork of the vehicle.
